(19) United States
(12) Patent Application Publication
(10) Pub. No.: US 2006/0173887 A1
(43) Pub. Date: Aug. 3, 2006

(54) Conversion of data in particular for playing of audio and/or video information

(76) Inventors: Volkmar Breitfeld, Dortmund (DE); Anders Fogh, Dortmund (DE)

Correspondence Address: ST. ONGE STEWARD JOHNSTON & REENS, LLC, 986 BEDFORD STREET, STAMFORD, CT, 06905-5619, US

(21) Appl. No.: 11/345,881

(22) Filed: Feb. 2, 2006

(30) Foreign Application Priority Data
Feb. 2, 2005 (DE) 10 2005 004 941.9

(51) Int. Cl. G06F 7/00

(52) U.S. Cl. 707/101

(57) ABSTRACT

A method for converting databases, structurally summarized in directories of data of an initial format meeting predetermined database specifications. The directory structure of the initial format is recorded. A directory structure of an intermediate format, having at least one database of data, is composed based on the directory structure of the initial format by at least one selection. The directory of the intermediate format is produced according to the selection. The contents of the database of data of the initial format are coded and correspond with the at least one database of data of the intermediate format in accordance with the directory of the intermediate format. The at least one database of data of the intermediate format is produced in accordance with the coding. Also, a method for reconstructive conversion of databases and a method for generating an initial format for feedback of audio and/or video information.

### CROSS-REFERENCE TO RELATED APPLICATIONS

The present application claims priority of German patent application No. 10 2005 004 941.9 filed on Feb. 2, 2005.

### FIELD OF THE INVENTION

The invention relates to a method for converting from databases, structurally summarized in directories, of data, preferably audio, video, and/or navigation information of said comprehensive data, of an initial format meeting predetermined specifications, into an intermediate format of databases, structurally summarized in directories of data, preferably audio, video, and/or navigation information of said comprehensive data. The invention further relates to a method for reconstructing databases, structurally summarized in directories, of data, preferably audio, video, and/or navigation information of said comprehensive data, of an initial format meeting predetermined specifications, from an inventive intermediate format of databases, structurally summarized in directories of data, preferably audio, video, and/or navigation information of the said comprehensive data. In addition the present invention relates to a method for producing an initial format for playback of audio and/or video information by means of at least one device for playback of audio and/or video information using an inventive intermediate format.

### BACKGROUND OF THE INVENTION

Known to the art are numerous initial formats including databases, structurally summarized in directories, of data, preferably audio, video, and/or navigation information of said comprehensive data. The initial formats here meet predetermined specifications, which as a rule are adapted to various digital media as physical data vehicles. Thus, for instance, digital media such as video compact discs (CDs) or digital versatile discs (DVDs) contain combinations of video and/or audio information together with navigation information on the same, that is, data which serve to control, define, and/or describe video and/or audio information and its behavior by means of a corresponding playback system for the video and/or audio information.

These data of audio, video, and/or navigation information on the same are usually not just subject to the specifications of the initial format and its physical medium, for instance a CD or DVD, but are also strongly dependent on one another and connected with one another. This requires that modifications on one of the components of the data, without corresponding modification of the other components of these data, lead as a rule to an invalid format, that is, in particular a format that no longer meets the necessary specifications or a format that functions and/or processes data according to the specifications.

With the standardized CD, DVD, and similar initial formats in the sense of the present invention, which are known from the art and widely distributed, the data of audio, video, and/or navigation information on the same are stored in several databases, so-called multiple files, in which continual data are found at various starting points referenced by a directory in or at defined positions of the particular physical medium. Time-dependent audio and/or video information is stored, as a rule, on the basis of mutually interspersed time and distance arrangements, which also include other additional data. To make possible a playback of corresponding audio and/or video information also by playback devices that are provided in accordance with the data or appropriate to it, with low or reduced capacity characteristics and/or behavior, such as the so-called bitrates, the data are stored or filed by the customary initial formats usually at firm and/or relatively firm positions of the physical medium, even if storage space in the physical medium is needlessly tied up as a result. The playback devices with reduced capacity characteristics and/or behavior, consequently, can be manufactured and disposed of at lower cost.

Previously known and used initial formats have various disadvantages with respect to their handling and/or manners of use. Thus, databases, structurally summarized in directories, of data, especially audio, video, and/or navigation information of said comprehensive data, in a format meeting predetermined specifications by means of a physical medium as a data vehicle, such as a CD or DVD, are generally so extensive that transmission over a network like the Internet or similar networks for data exchange is excessively time-consuming and costly. In addition, it has so far been impossible, from data, in particular audio, video, and/or navigation information on said comprehensive data, of an initial format meeting predetermined specifications, to assemble databases selected only for individual users and to transmit them usefully in keeping with the initial format as databases over networks. With customary initial formats in their used physical media or data vehicles, in addition, storage space is needlessly occupied. In transmission by networks, especially for data exchange, this unused storage space is, or must be, disadvantageously transmitted at the same time.

For archiving and/or improving the exchange of databases, structurally summarized in directories, of data, preferably audio, video, and/or navigation information on said comprehensive data, of an initial format meeting predetermined specifications, it is customary in prior art, with a view to required storage capacity, to code altogether the databases structurally summarized in indexes of data of the initial format meeting predetermined specifications and to pack them in a database of continually successive data. In this manner the required storage space of the databases of data of the initial format can be reduced, but no individual user-oriented selection of databases of data of the initial format can be configured, nor is it possible to use the database assembled in this way, especially according to the databases of data of the initial format.

### SUMMARY OF THE INVENTION

In view of this state of the art, it is the object of the present invention to produce a conversion of databases, structurally summarized in directories, of data, especially audio, video, and/or navigation information on said comprehensive data, of an initial format meeting predetermined specifications, into an intermediate format of databases structurally summarized in indexes of data, preferably audio, video, and/or navigation information on said comprehensive data, which, while avoiding the above-described disadvantages, allows for an improved and more extensive use of databases of data of an initial format meeting predetermined specifications. At the same time, databases of data of an initial format meeting predetermined specifications should in particular be selectable for the individual user, requiring less storage capacity than with the initial format and, while maintaining as far as possible the handling and/or application possibilities of the initial format, should be exchangeable, especially by way of networks.

For the technical solution, a method for converting databases, structurally summarized in databases, of data, preferably audio, video, and/or navigation information on said comprehensive data, of an initial format meeting predetermined specifications, into an intermediate format of databases, structurally summarized in databases, of data, preferably audio, video, and/or navigation information on said comprehensive data, is proposed, so that the directory structure of the initial format is recorded, and a directory structure of the intermediate format, comprising at least one database of data, is assembled on the basis of the directory structure of the initial format by at least one selection, and the directory of the intermediate format is compiled in accordance with the selection, and the contents of the database of data of the initial format corresponding with the at least one database of data of the intermediate format, in accordance with the directory of the intermediate format, are coded, and the at least one database of data of the intermediate format is produced in accordance with the coding.

According to the invention, a directory structure in accordance with the directory structure of the initial format is compiled by means of the intermediate format in accordance with the choice of databases of data of the initial format. At the same time, functionalities of the directory structure of the initial format are accordingly retained, advantageously, by means of the directory structure of the intermediate format and are accordingly usable on the databases of data of the intermediate format, which correspond, with reduced storage space requirements, with the contents of the databases of data of the initial format in accordance with the selection by means of the coding. By means of the inventive conversion, databases of data of the initial format can be selected according to the individual user, while the handling and/or possible uses of databases of data of the initial format by means of the intermediate format remain preserved at least to a great extent and, because of the reduced storage space required by the coding of the contents of the databases by the intermediate format, this intermediate format can be exchanged more quickly and cost-effectively, in particular over networks such as the Internet or similar data exchange networks.

The at least one database of data of the intermediate format is advantageously produced in connection with the coding of the contents of all databases of data of the initial format in accordance with the directory of the intermediate format. As a result it can be ensured that in the directory of the intermediate format the corresponding positions and/or pointers to positions of the selected contents are available and the corresponding possibilities for handling and/or uses of databases of data of the initial format are guaranteed.

The directory of the intermediate format is advantageously corrected after coding in accordance with the result of the coding. In the process, in the context of the correction of the directory of the intermediate format, there is advantageously an adjustment of the directory structure to the at least one database of data of the intermediate format in accordance with the coding, especially with respect to the particular data information of the database.

According to an advantageous proposal of the invention, databases of data are produced by means of the intermediate format as a continuous data stream. This ensures that no unused storage space is required on the part of the intermediate format.

In an advantageous embodiment of the invention, navigation information on databases of data in accordance with the directory of the intermediate format are recorded by the intermediate format independently of the other content information of the databases of data in accordance with the directory of the intermediate format. In the process, advantageously, the navigation information on the databases of data in accordance with the directory of the intermediate format is compiled, by means of the intermediate format, in one database and the other content information on the databases of data in accordance with the directory of the intermediate format is compiled in another database.

According to an additional advantageous proposal of the invention, the database comprising the navigation information on the databases of data in accordance with the directory of the intermediate format is given precedence in the data stream over the database comprising the other content information on databases of data in accordance with the directory of the intermediate format. Consequently, a so-called interleaving of data occurs, ensuring that, when the intermediate format is entered by means of a device for processing the intermediate format, for instance for feedback of audio and/or video information, first the navigation information is compiled which serves for the control, definition, and/or description of the video and/or audio information and its behavior on the part of a corresponding playback system for the video and/or audio information.

In an additional advantageous embodiment of the invention, in the context of the coding, navigation information of the at least one database of the initial format in the intermediate format corresponding to the particular size of the coded other content information of the database of data of the initial format corresponding with the at least one database of data of the intermediate format, in keeping with the directory of the intermediate format, is converted and secured. In the process, in the context of the conversion and securing, a corrective adjustment of the intermediate format advantageously occurs in accordance with the result of the coding.

Production of the continuous data stream of databases of data of the intermediate format advantageously occurs by means of multiplexes, that is, interspersing of the navigation information of the databases of data, in accordance with the database comprising the directory of the intermediate format, with the databases comprising other content information on databases of data in accordance with the directory of the intermediate format.

According to an additional advantageous proposal of the invention, information is reported on characteristics of the database of data of the initial format that correspond with the at least one database of data of the intermediate format in accordance with the directory of the intermediate format.

Information on characteristics in the sense of the present invention are thus valid, in particular, for the totality of the data or else disclose inward effects concerning these data. An additional advantageous embodiment of the invention is characterized by the use of information on characteristics of the database of data of the initial format that correspond with the at least one database of data of the intermediate format in accordance with the directory of the intermediate format, for reconstructing navigation information and/or positions of databases of data of the initial format. Consequently, as needed, the initial format and/or at least one format meeting the specifications of the initial format can advantageously be compiled from the intermediate format. The size of the database of data of the initial format is advantageously used as information on characteristics.

Another particularly advantageous embodiment of the invention is characterized by algorithms for coding, adjusted to the respective contents of the at least one database of data, preferably to the coding of audio, video, and/or navigation information on said adjusted algorithms. Thus, for various databases of data types, in particular audio data, video data, text data, image data, or the like data, various algorithms for coding can be used, in particular algorithms that provide optimal coding results for the respective data types in accordance with the respective preferences or requirements, for instance with quality and/or similar characteristics. The ITU-T h 264 (MPEG4-AVC video), MPEG4 (ISO/IEC 14496), Dolby AC3, MP3, and/or WMV algorithms are advantageously used.

Advantageously, characteristic traits of the contents of the at least one database of data are recorded and stored In the context of the coding, preferably characteristic traits of the contents of the at least one database of data of the initial format and/or of the intermediate format. Characteristic traits of a database in the sense of the present invention are based here on modifiable contents of a database, in particular those that take effect directed outward. An advantageous embodiment of the invention is marked by the use of the stored characteristic traits of the contents of the at least one database of data for the most extensive possible reconstruction of the at least one database of data of the initial format. An additional embodiment of the invention is marked by the use of the series of databases of data, the maximal bitrates for an audio and/or video data feedback, by image movements, video traits like dissolves, fade, scene detection, motions and the like, of the visual complexity and/or transitions in the volume of audio information as characteristic traits.

According to another advantageous embodiment of the invention, the data of the databases of the initial format are arranged on a data vehicle at predetermined positions labeled by the directory structure of the initial format. Here the data of the databases of the initial format can be situated on a data vehicle continuously, that is in particular without distances from one another, immediately following one another, at predetermined positions labeled over the directory structure of the initial format. The predetermined positions are advantageously set firmly and/or relatively firmly. In a preferred embodiment, the initial format is subject to DVD specifications, preferably DVD video specifications, in particular based on the “DVD Specifications for Read-Only Disc” of Hitachi, Ltd., Koninklijke Phillips Electronics N.V., Matsushita Electric Industrial Co. LTD, Mitsubishi Electric Corporation, Pioneer electronic corporation, Sony corporation, Thomson multimedia, Time Warner Inc., Toshiba Corp., and Victor Company of Japan Ltd. The firmly and/or relatively firmly set predetermined positions here are, for example, produced in or corresponding to the so-called “video ts ifo.” In another embodiment of the invention the initial format is subject to CD specifications, preferably video-CD and/or super video-CD and/or audio-CD specifications.

According to a particularly advantageous proposal of the invention, bibliographical information on the audio and/or video information can be built into the intermediate format, preferably bibliographic information that allows a user-specific categorization and/or sorting of the audio and/or video information.

With the present invention, in addition, a method for reconstructive conversion of databases, structurally combined in directories, of data, preferably audio, video, and/or navigation information on said comprehensive data, of an initial format meeting predetermined specifications, from an inventive intermediate format of databases, structurally combined in directories, of data, preferably audio, video, and/or navigation information on said comprehensive data, where the directory structure of the intermediate format is compiled from the at least one database of the intermediate format, on the basis of the directory structure of the intermediate format, by at least one selection, a directory structure of the initial format, comprising at least one database of data, is converted and produced, the contents of the database, corresponding with the at least one database of data of the initial format in accordance with the directory of the initial format, of data of the intermediate format are coded and the at least one database of data of the initial format is produced in accordance with the coding.

Advantageously, in the context of the reconstructive conversion of the directory structure of the initial format, in addition to the directory structure of the intermediate format, information on characteristics of the database, corresponding with the at least one database of data of the intermediate format in accordance with the directory of the intermediate format, of data of the initial format and/or characteristic traits of the contents of the at least one database of data are used.

In the framework of coding, navigation information on the at least one database of the intermediate format is advantageously recorded, and converted and secured in accordance with the specifications of the initial format. The other content information on the at least one database of the intermediate format, in the framework of coding, is advantageously recorded and converted and secured in accordance with the specifications of the initial format. The other content information here advantageously comprises characteristic hallmarks and/or traits of the intermediate format, preferably video hallmarks like fade, scene detection, dissolves, bitrates, motion, size, and the like.

In addition, with the present invention, a method is provided for producing an initial format for feedback of audio and/or video information on the part of the at least one device for feedback of audio and/or video information while using an inventive intermediate format, where, however, from the at least one database of data of the intermediate format, navigation information on audio and/or video information is recorded and audio and/or video information in accordance with the navigation information is fed back by the at least one device for feedback of audio and/or video information. Production of an initial format for feedback of audio and/or video information, preferably a monitor device according to the PAL/NTSC format comprising, while using an inventive intermediate format, advantageously dispenses with the need for additional devices otherwise required for feedback of initial information, for example CD and/or DVD player appliances or numeric devices with corresponding software. According to the invention, from the intermediate format an initial format is advantageously produced which conforms to the PAL/NTSC format.

In an additional advantageous embodiment of the invention the initial format is produced for feedback of audio and/or video information on the part of the at least one device for feedback of audio and/or video information in the form of a database that can be executed by the at least one device for feedback of audio and/or video information. In the process, the database contains information adapted to the at least one device for feedback of audio and/or video information for control and conversion of the audio and/or video information on the part of the at least one device for feedback of audio and/or video information in accordance with, or from, the intermediate format. In the process, the executable database is advantageously configured in such a way that it includes in a database of data the converter required for feedback of audio and/or video information, a so-called software player, and the converting intermediate format.

An advantageous configuration of the invention is marked by at least one selection input by an input device of the at least one device for feedback of audio and/or video information for navigation in the audio and/or video information while using the navigation information. Such a selection input can advantageously take place by means of remote operation or similar input device of a device for feedback of audio and/or video information, for example for so-called forward or back-reeling or forward or back-springing into or between individual audio and/or video parts or sequences.

The at least one database of data of the intermediate format and/or the selection input for navigation in the audio and/or video information while using navigation information are advantageously transmitted between the at least one device for feedback of audio and/or video information and a numeric device that includes the at least one database of data of the intermediate format, preferably over a network. Consequently the at least one device for feedback of audio and/or video information can be configured exclusively for this functionality, because numeric operation required for the conversion, in particular decodings, conversions, and the like, can be executed by the numeric device. In addition, several feedback devices that include various audio and/or video feedback formats can be advantageously supplied with corresponding audio and/or video information by a numeric device, which must thus be capable of executing and processing corresponding numeric operations. The transmission advantageously proceeds unidirectionally over various transmission paths or canals so that the at least one database of data of the intermediate format is advantageously transmitted from the numeric device that includes the at least one database of data of the intermediate format, to the at least one device for feedback of audio and/or video information over a transmission path or canal, and the selection input for navigation in the audio and/or video information while using the navigation information transmitted from an input device configured in accordance therewith, in particular a remote operation, over another transmission path or canal to the numeric device that includes at least one database of data of the intermediate format.

A particularly advantageous configuration of the invention is characterized in that the intermediate format is converted by means of the numeric device into audio and/or video information that can be fed back by means of the at least one device for feedback of audio and/or video information and the converted audio and/or video information is transmitted by the numeric device over the network to the at least one device for feedback of audio and/or video information and is fed back by means of the at least one device for feedback of audio and/or video information.

Additional details, characteristics, and advantages of the invention are examined in greater detail hereafter with reference to the illustrations.

### BRIEF DESCRIPTION OF THE DRAWINGS

FIG. 1 shows, in a schematic view, a theoretical embodiment of an inventive conversion of an initial format into an intermediate format.

FIG. 2 shows, in a schematic block diagram, an additional theoretical embodiment of an inventive conversion of an initial format into an intermediate format.

FIG. 3 shows, in a schematic block diagram, a theoretical embodiment of an inventive reconstruction of an initial format from an intermediate format according to FIG. 2.

FIG. 4 shows, in a schematic block diagram, a theoretical embodiment of an inventive production of an initial format for feedback of audio and/or video information by means of at least one device for feedback of audio and/or video information while using an intermediate format.

FIG. 5 shows, in schematic block diagram, details of an embodiment of an inventive production of an initial format for feedback of audio and/or video information by means of at least one device for feedback of audio and/or video information while using an intermediate format.

### DETAILED DESCRIPTION OF THE INVENTION

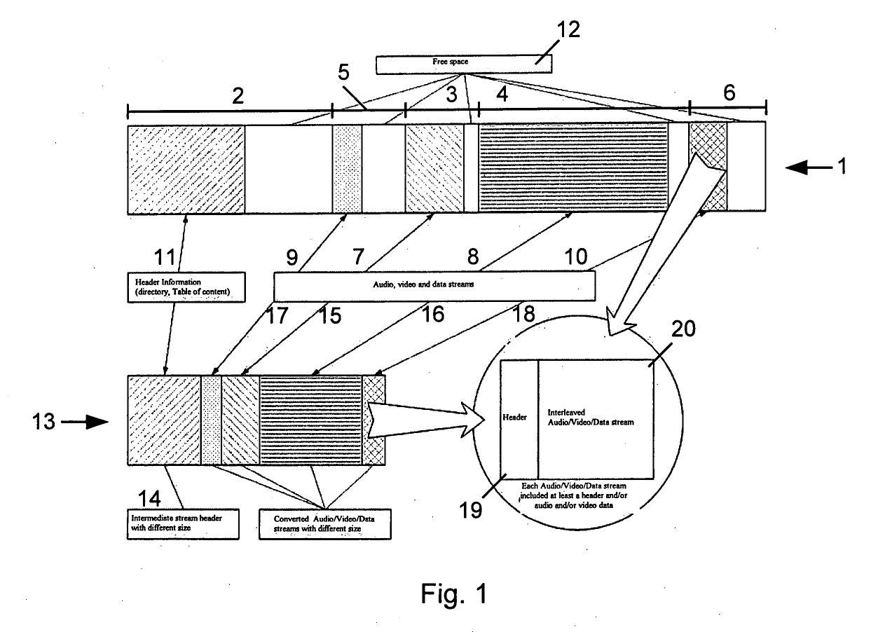

FIG. 1 shows the arrangement of databases 3, 4, 5, and 6, structurally summarized in a directory 2, of data of an initial format 1 that meets predetermined specifications, primarily audio, video, and navigation on said comprehensive data 7, 8, 9, and 10 in accordance with the DVD specifications. In the process, the directory 2 and the databases 3, 4, 5, and 6 of data 7, 8, 9, and 10, in accordance with the DVD specifications, are arranged, in accordance with the DVD specs, as an initial format 1 on a physical data vehicle, primarily a DVD, at positions that are firmly and/or relatively firmly predetermined, that is, firmly in connection with one another. Thus, in the DVD specifications as initial format 1, the positions of beginning and end of the directory 2 are firmly or absolutely predetermined, while for example the starting position of the database 8 is relatively firm, because it depends primarily on the sizes of the previously arranged databases 3 and 5. According to the DVD specification 1, the arrangement of the directory 2 and of the databases 3, 4, 5, and 6, in this process, is based on mutually interspersed time and distance arrangements of the same. Here, storage space areas predetermined according to the DVD specification 1 are available to the directory 2 and the databases 3, 4, 5, and 6, which areas are not fully utilized primarily by the contents 11 of the directory 2 and the data 7, 8, 9, and 10 of the databases 3, 4, 5, and 6. The directory 2 and the databases 3, 4, 5, and 6 accordingly have free storage places 12.

In the context of converting the initial format into an intermediate format, first the structure of the directory 2 of the initial format is recorded. Primarily the contents 11 of the directory 2 are inputted and provisionally stored. Then, by means of the provisionally stored directory structure of the initial format, a directory structure of the intermediate format 13 is compiled through individual user selection, which intermediate format 13 comprises databases 3, 4, 5, and 6 of data, which are of interest to and desired by the user, in accordance with the initial format 1. In accordance with the selection, then, the directory 14 of the intermediate format 13 is then produced. This format primarily comprises databases 15, 16, 17, and 18. Then the contents of the databases 3, 4, 5, and 6 of data of the initial format 1 corresponding with databases 15, 16, 17, and 18 of data of the intermediate format 13 in accordance with the directory 14 of the intermediate format 13 are coded. In the process, various algorithms for coding, adapted to the individual particular contents, are used for the individual data 7, 8, 9, and 10, which primarily form the actual contents of databases 3, 4, 5, and 6, and the databases 15, 16, 17, and 18 of data of the intermediate format 13 in accordance with the particular coding. As can be recognized from FIG. 1, the directory 14 and the databases 15, 16, 17, and 18 of the intermediate format 13 here have no free spaces in their storage area, and thus no unused storage space areas 12 are available like those provided by the initial format 1.

The directory 14 and the databases 15, 16, 17, and 18 of the intermediate format 13 are primarily further produced as a continuous data stream consisting of two successive databases 19 and 20 by means of a subsequent multiplex of the directory 14 with the databases 15, 16, 17, and 18 after their coding. In the process, the database 19 contains the information available in the directory 14 and the database 20 has the information according to the databases 15, 16, 17, and 18.

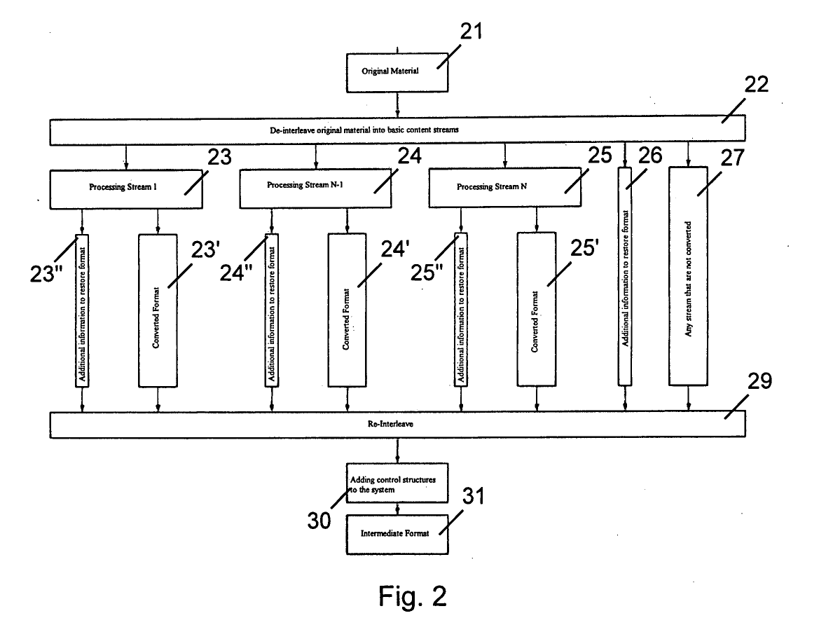

FIG. 2 shows an initial format 21 that meets a predetermined specification and which primarily contains databases, structurally summarized in a directory, of data in the form of a continuous data stream 22. From the data stream 22, in the context of conversion in accordance with the individual user's selection based on the directory or the directory structure of the initial format 21, databases 23, 24, and 25 are assembled of data which are also present primarily as data streams, as well as additional information 26 and 27 on characteristics of the databases 23, 24, and 25 or of the initial format 21. The information 26 here is primarily information which need not be converted. The composition of the intermediate format 31 here occurs also in a data stream 29. In the context of the composition of the data stream 29, the databases 23, 24, and 25 of data re coded in accordance with their particular contents. This process in accordance with the particular data contents of the databases 23, 24, and 25 makes use primarily of various coder algorithms 23′, 24′, and 25′, which in addition produce and convey additional information 23″, 24″, and 25″ which serves in addition for the reconstruction of databases 23, 24, and 25 of the initial format 21, and report the information by means of the data stream 29. The databases 23′, 23″, 24′, 24″, 25′, 25″, 26, and 27, filed accordingly in the data stream 29, are provided with a corresponding directory 30 in accordance with their arrangement or structure in the data stream 29 of the intermediate format 31.

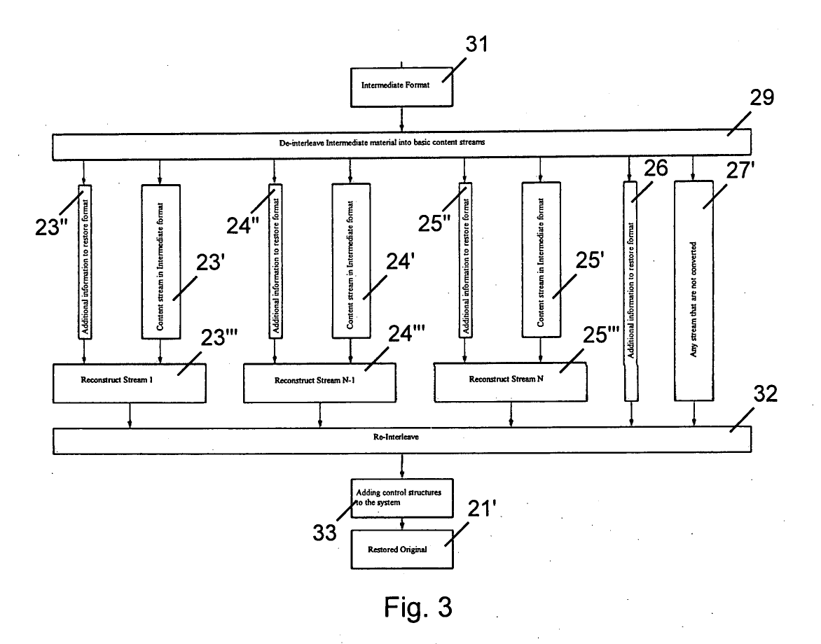

FIG. 3 shows the reconstruction of the initial format 21 according to FIG. 2 that is the closest approximation to the original, primarily identified with the reference number 21′, from the intermediate format 31. Here the directory structure 30 of the intermediate format 31 is recorded, and the databases 23′, 23″, 24′, 24″, 25′, 25″, 26, and 27′, present in the continuous data stream 29 of the intermediate form, of the data in accordance with the specifications of the initial format 21′ that is to be produced, are reconstructed and produced in a data stream 32. In the framework of reconstruction, in each case the databases 23″, 24″, and 25″ are coded here from the databases 23′, 23″, 24′, 24″, and 25′, 25″ in accordance with the specifications of the initial format 21′ that is to be produced and are accordingly produced. The data stream 32 of the reconstructive initial format 21′ is provided with a corresponding directory structure 33 for itself in accordance with the arrangement of the databases 23″, 24″, 25″, 26, and 27′.

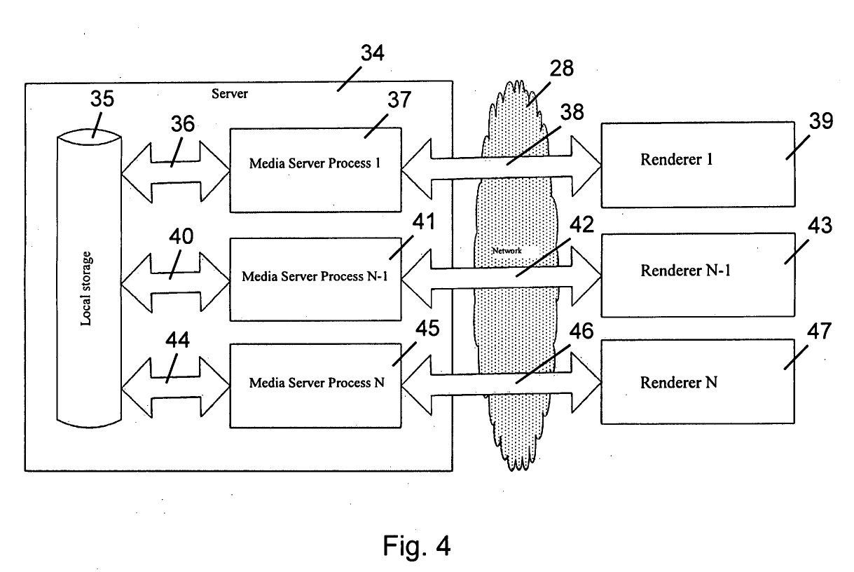

FIG. 4 shows the generation 36, 40, and 44 of initial formats 39, 41, and 45 for feedback of audio and/or video information while using an inventively produced intermediate format 35. Here the initial formats 37, 41, and 45 are generated from the intermediate format 35 by means of a numeric device 34, and the corresponding data of the initial formats 37, 41, and 45 are conducted to the feedback devices 39, 43, and 47 localized at various sites in the framework of a data exchange 38, 42, and 46 for feedback over a network 28, primarily a local network, that is for example a house-internal network, or else over the Internet.

By means of the feedback devices 39, 43, and 47, devices are present which make possible a selective input for navigating in the navigation information of the initial formats 37, 41, and 45, primarily remote operations, not shown here, or similar input devices, which in particular have an influence on the time flow of the contents of the initial formats 37, 41, and 45 through so-called forward and reverse springs and/or forward or reverse spooling in audio and/or video information of the initial formats 37, 41, and 45. Here the corresponding information of the selection inputs with the data exchange connections 38, 42, and 46 are conducted over the network 28 from the respective feedback devices 39, 43, and 47 to the numeric device 34 and are correspondingly taken into account in the framework of the respective generation 36, 40, and 44 of the initial formats 37, 41, and 45 from the intermediate format 35.

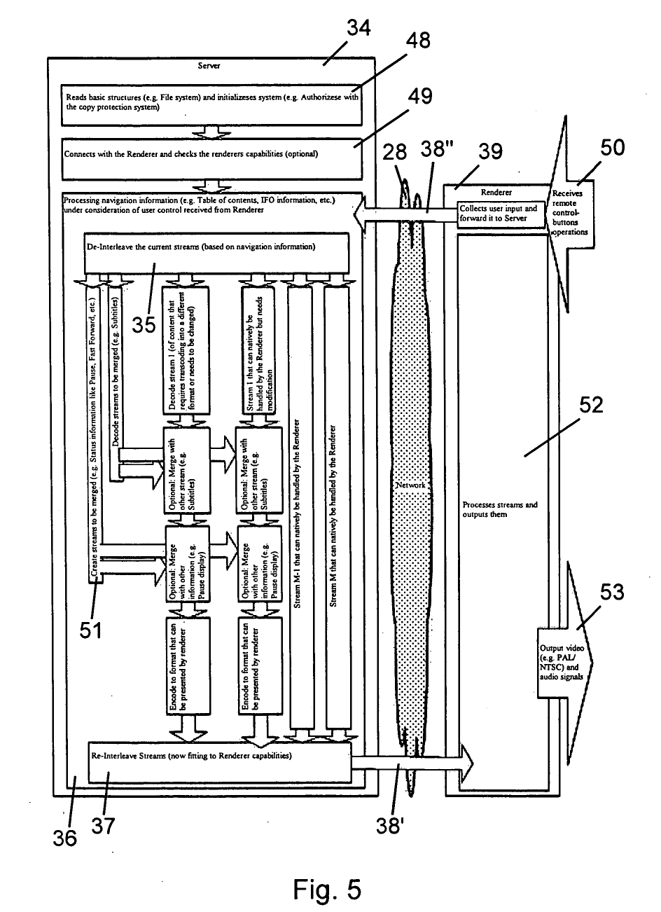

The flowchart shown in detail in FIG. 5 represents the framework of the generation of the initial format from the intermediate format and of the exchange of the initial format by means of the numeric device 34 and a device 39 for feedback of audio and/or video information which can be connected with one another over the network 28.

In the step of the procedure labeled as 48, the directory structure is first entered, and possibly additional characteristics, such as use calculations, legitimacy, or similar information, of the intermediate format 35 by means of the numeric device 34 operated primarily as a server. Then, in the optional step of the procedure labeled as 49, the technical capabilities of the device 39 for feedback of audio and/or video information, such as processable bitrates, feedback profiles, processable coder algorithms, and the like, are recorded. These technical capabilities of the device 39 for feedback of audio and/or video information are taken into consideration hereafter in the inventive generation 36 of the initial format 37 from the intermediate format 35.

In the framework of the generation 36 of the initial format 37, the individual databases of data for the particular initial format 37 are generated by coding and/or conversion from the directory to the database of the intermediate format 35 similarly to the reconstruction according to FIG. 3. The initial format 37 is here configured as a continuous data stream, which is transmitted over the network 28 to the feedback device 39. The transmission is depicted in FIG. 5 by the arrow marked with reference number 38′.

In the generation 36 of the data stream 37 from the intermediate format 35, in addition to databases, generated from the directory and the database of the data of the intermediate format 35, of data of the initial format 37, as shown in FIG. 5, by means of remote operation of the feedback device 39 by a user, information is taken into consideration which comes by means of a selection input 50 that in particular comprises a navigation in the information to be fed back. This selection input 50 is recorded by means of the feedback device 39 and transmitted to the numeric device 34 over the network 28. The transmission is shown in FIG. 5 by the arrow marked with reference number 38″. The selection input 50 is taken into consideration in the context of the generation 36 of the initial format 37 from the intermediate format 35 in the step of the procedure labeled as 51 and accordingly influences the generation of the databases of data of the initial format 37. The conversion of the initial format 37 by the feedback device 39 occurs in the step of the procedure labeled 52 in FIG. 5 and is performed by the feedback device 39. The feedback is shown in FIG. 5 with the arrow marked with reference number 53.

The embodiments of the present invention shown in the illustrations serve only to elucidate the invention and are not restrictive with respect to said invention.

1. A method for converting databases, structurally summarized in directories, of data of an initial format meeting predetermined specifications of databases, structurally summarized in directories, of data, so that the directory structure of the initial format is recorded, a directory structure of the intermediate format, comprising at least one database of data, is composed on the basis of the directory structure of the initial format by at least one selection, the directory of the intermediate format is produced in accordance with the selection, the contents of the database, corresponding with the at least one database of data of the intermediate format in accordance with the directory of the intermediate format, of data of the initial format are coded, and the at least one database of data of the intermediate format in accordance with the coding is produced.

2. A method according to Claim 1, characterized in that the at least one database of data of the intermediate format in connection with the coding of the contents of all databases of data of the initial format is produced in accordance with the directory of the intermediate format.

3. A method according to Claim 1, characterized in that the directory of the intermediate format is corrected after the coding in accordance with the result of the coding.

4. A method according to Claim 1, characterized in that databases of data are produced as a continual data stream by means of the intermediate format.

5. A method according to Claim 1, characterized in that navigation information on databases of data in accordance with the directory of the intermediate format is recorded by means of the intermediate format independently of the other content information of the databases of data in accordance with the directory of the intermediate format.

6. A method according to Claim 5, characterized in that the navigation information on the databases of data is recorded in a database by means of the intermediate format in accordance with the directory of the intermediate format.

7. A method according to Claim 5, characterized in that the other content information of the databases of data in accordance with the directory of the intermediate format is recorded in a database by means of the intermediate format.

8. A method according to Claim 7, characterized in that the database that comprises the navigation information of the databases of data by means of the intermediate format in accordance with the directory of the intermediate format, has precedence in the data stream over the database that comprises the other content information of the databases of data in accordance with the directory of the intermediate format.

9. A method according to any Claim 1, characterized in that in the framework of the coding, navigation information of the at least one database of the initial format is converted and secured in the intermediate format in accordance with the respective size of the coded other content information of the database, which corresponds with the at least one database of data of the intermediate format in accordance with the directory of the intermediate format, of data of the initial format.

10. A method according to Claim 4, characterized in that the continual data stream of databases of data of the intermediate format is produced by means of interspersing of the database that comprises navigation of the databases of data in accordance with the directory of the intermediate format, with the databases that comprise other content information of the databases of data in accordance with the directory of the intermediate format.

11. A method according to Claim 1 , characterized in that information on characteristics of the database, corresponding with the at least one database of data of the intermediate format in accordance with the directory of the intermediate format, of data of the initial format is recorded by means of the intermediate format.

12. A method according to Claim 11, characterized by a use of the information on characteristics of the database, corresponding with the at least one database of data of the intermediate format in accordance with the directory of the intermediate format, of data of the initial format for reconstruction of navigation information and/or positions of databases of data of the initial format.

13. A method according to Claim 11, characterized by the size of the database of data of the initial format as information on characteristics.

14. A method according to Claim 1, characterized by algorithms for coding, adapted to the respective contents of the at least one database of data.

15. A method according to Claim 1, characterized in that in the context of the coding, characteristic traits of the contents of the at least one database of data are recorded and stored.

16. A method according to Claim 15, characterized by a use of the stored characteristic traits of the contents of the at least one database of data for the closest possible reconstruction of the at least one database of data of the initial format.

17. A method according to Claim 15, characterized by the series of databases of data, the maximal bitrates for an audio and/or video data feedback, image movements, video characteristics, visual complexity, and/or transitions in the volume of audio information as characteristic traits.

18. A method according to of Claim 1, characterized in that the data of the databases of the initial format are arranged at predetermined positions on a data vehicle referenced by the directory structure of the initial format.

19. A method according to Claim 18, characterized in that the predetermined positions are set forth firmly and/or relatively firmly.

20. A method according to Claim 1, characterized in that the initial format is subject to DVD specifications.

21. A method according to Claim 1, characterized in that the initial format is subject to CD specifications.

22. A method according to Claim 1, characterized in that bibliographical information on the audio and/or video information can be bound into the intermediate format.

23. A method for reconstructive conversion of databases, structurally summarized in directories, of data, of a predetermined initial format meeting predetermined specifications, from an intermediate format of databases, structurally summarized in directories, of data, according to Claim 1, wherein, from the at least one database of data of the intermediate format the directory structure of the intermediate format is recorded, a directory structure of the initial format, comprising at least one database of data, is converted and produced on the basis of the directory structure of the intermediate format by at least one selection, the contents of the database, corresponding with the at least one database of data of the initial format in accordance with the directory of the initial format, of data of the intermediate format are coded and the at least one database of data of the initial format is produced in accordance with the coding.

24. A method according to Claim 23, characterized in that in the framework of the reconstructive conversion of the directory structure of the initial format, in addition to the directory structure of the intermediate format, information on characteristics of the database, corresponding with the at least one database of data of the intermediate format in accordance with the directory of the intermediate format, of data of the initial format are used, further characterized in that information on characteristics of the database, corresponding with the at least one database of data of the intermediate format in accordance with the directory of the intermediate format, of data of the initial format is recorded by means of the intermediate format.

25. A method according to Claim 23, characterized in that in the framework of coding navigation information on the at least one database of the intermediate format is recorded, and converted and secured in accordance with the specification of the initial format.

26. A method according to Claim 23, characterized in that in the framework of coding the other content information of the at least one database of the intermediate format is recorded, and converted and secured in accordance with the specification of the initial format.

27. A method for generating an initial format for feedback of audio and/or video information by at least one device for feedback of audio and/or video information while using an intermediate format according Claim 1, wherein, from the at least one database of data of the intermediate format, navigation information on audio and/or video information is recorded, and audio and/or video information is fed back in accordance with the navigation information by means of the at least one device for feedback of audio and/or video information.

28. A method according to Claim 27, characterized in that the generation of the initial format for feedback of audio and/or video information by means of the at least one device for feedback of audio and/or video information takes place in the form of a database that can be executed by means of the at least one device for feedback of audio and/or video information.

29. A method according to Claim 27, characterized by at least one selection input by means of an input device of the at least one device for feedback of audio and/or video information for navigation in the audio and/or video information while using the navigation information.

30. A method according to Claim 27, characterized in that the at least one database of data of the intermediate format and/or the selection input for navigation in the audio and/or video information while using the navigation information are transmitted between the at least one device for feedback of audio and/or video information and a numeric device that includes the at least one database of data of the intermediate format.

31. A method according to Claim 30, characterized in that the transmission occurs unidirectionally over various transmission paths or transmission canals.

32. A method according to Claim 30, characterized in that the intermediate format is converted by means of the numeric device into audio and/or video information that can be fed back by means of the at least one device for feedback of audio and/or video information, and the converted audio and/or video information is fed back by the numeric device over a he network to the at least one device for feedback of audio and/or video information, and is fed back by means of the at least one device for feedback of audio and/or video information.

33. A method according to Claim 1, wherein the data of an initial format comprise audio, video, and/or navigation information on the same comprehensive data.

34. A method according to Claim 1, wherein the data of the predetermined specifications of databases comprise audio, video, and/or navigation information on the same comprehensive data.

35. A method according to Claim 14, wherein the algorithms are for the coding of audio, video, and/or navigation information on said adapted algorithms.

36. A method according to Claim 15, wherein the characteristic traits are of the contents of the at least one database of data in the initial format and/or in the intermediate format.

37. A method according to Claim 20, wherein the initial format is subject to a DVD-video specification.

38. A method according to Claim 21, wherein the CD specifications comprise at least one of a video-CD specification, a super video-CD specification and an audio-CD specification.

39. A method according to Claim 22, wherein the bibliographical information makes possible at least one of a user-specific categorization of the audio and/or video information and a user-specific sorting of the audio and/or video information.

40. A method according to Claim 23, wherein the data of a predetermined initial format comprise audio, video, and/or navigation information on the same comprehensive data.

41. A method according to Claim 23, wherein the data of the intermediate format of databases comprise audio, video, and/or navigation information on the same comprehensive data

42. A method according to Claim 23, characterized in that in the framework of the reconstructive conversion of the directory structure of the initial format, in addition to the directory structure of the intermediate format, information on characteristics of the database, corresponding with the at least one database of data of the intermediate format in accordance with the directory of the intermediate format, of data of the initial format, and characteristic traits of the content of the at least one database of data are used, characterized in that in the context of the coding, characteristic traits of the contents of the at least one database of data are recorded and stored.

43. A method according to Claim 42, wherein the characteristic traits are of the contents of the at least one database of data in the initial format and/or in the in- termediate format.

44. A method according to Claim 30, wherein the transmission is over a net- work.
